(19) United States
(12) Patent Application Publication
(10) Pub. No.: US 2009/0144099 A1
(43) Pub. Date: Jun. 4, 2009

(54) METHOD AND SYSTEM FOR NEGOTIATING A WORK ORDER

(76) Inventors: Eduard KORAT, Campbell, CA (US); Cora ZIMMERMANN, Belmont, CA (US)

Correspondence Address: SAP AG, 3410 HILLVIEW AVENUE, PALO ALTO, CA, 94304, US

(21) Appl. No.: 11/947,803

(22) Filed: Nov. 30, 2007

(51) Int. Cl. G06Q 10/00

(52) U.S. Cl. 705/7

(57) ABSTRACT

What is described is a method and system for negotiating work orders. A work order comprising delivery information is provided. A negotiation action is performed for the delivery information. A first input and output pair including a first transport phase input and a first transport phase output is detected in a transport phase for the delivery information. A second input and output pair including a second production phase input and a second production phase output linked to the first input and output pair is determined in a production phase. The negotiation action is applied to the second input and output pair.

### FIELD OF THE INVENTION

Embodiments of the invention generally relate to the field of supply network collaboration and more specifically to a method and a system for negotiating a work order.

### BACKGROUND OF THE INVENTION

A collaboration system provides collaboration of business objectives in a supply chain network. Collaboration systems enable users to collaborate in the creation of documents and other electronic records. Collaboration technologies deliver the functionality for many entities to enhance common deliverable information. Such collaboration systems include telephone, e-mail, synchronous conferencing, instant messaging, faxing, voice mails, video conferencing, and the like. Collaboration tools facilitate and manage group activities. Examples of collaborative tools include electronic calendars, work flow systems, knowledge management, project management, online documents and the like.

Existing collaboration systems enable exchange of information between two or more entities and altering one or more components of a business process. Examples of business processes include development of an idea, creation of a design, outsourced production and the like. Second users and first users may want to closely integrate and co-ordinate with each other for a product development and production. The collaboration system helps entities integrate their business process and create additional value through integration. There is a need for the entities to react in sufficient time on components in a business process that are missing or products whose yield is low. Therefore, a system is required for allowing negotiation on a product specification and reaching an agreement based upon the negotiation.

### SUMMARY OF THE INVENTION

Embodiments of the invention are generally directed to a method and system for negotiating work orders. A work order comprising delivery information is provided. A negotiation action is performed for the delivery information. A first input and output pair including a first transport phase input and a first transport phase output is detected in a transport phase for the delivery information. A second input and output pair including a second production phase input and a second production phase output linked to the first input and output pair is determined in a production phase. The negotiation action is applied to the second input and output pair.

These and other benefits and features of embodiments of the invention will be apparent upon consideration of the following description of embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for negotiating a work order according to an embodiment of the invention.

FIG. 2 is a flow diagram of a process for negotiating a work order according to an embodiment of the invention.

FIG. 3 is a flow diagram of a process for rejecting a work order according to an embodiment of the invention.

FIG. 4 is a flow diagram of a process for counter proposing a work order according to an embodiment of the invention.

FIG. 5 is a flow diagram of a process for modifying a work order according to an embodiment of the invention.

FIG. 6 is a block diagram of a system for negotiating a work order according to an embodiment of the invention.

### DETAILED DESCRIPTION

Embodiments of the invention are generally directed to a method and system for negotiating work orders. A work order comprising delivery information is provided. A negotiation action is performed for the delivery information. A first input and output pair including a first transport phase input and a first transport phase output is detected in a transport phase for the delivery information. A second input and output pair including a second production phase input and a second production phase output linked to the first input and output pair is determined in a production phase. The negotiation action is applied to the second input and output pair.

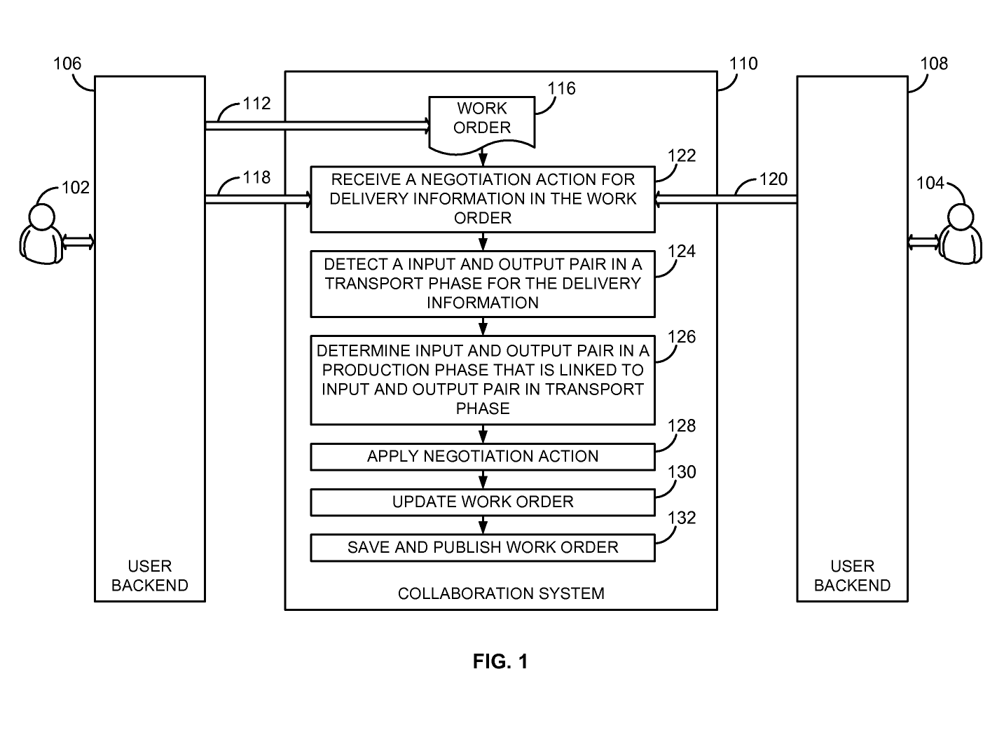

FIG. 1 is a functional block diagram of a system for negotiating a work order according to an embodiment of the invention. User backend 106 is typically maintained by user 102 and user backend 108 is typically maintained by user 104. Collaboration system 110 generally helps collaboration between user backend 106 and user backend 108. In an embodiment, work order 116 is sent at 112 by user 102 through user backend 106 to collaboration system 110. In an embodiment, work order 116 is sent by user 104 through user backend 108 to collaboration system 110. In an embodiment, a purchase order may be generated by user 102 in user backend 106 for a supply of goods or products from user 104. Based on the purchase order, work order 116 may be generated in collaboration system 110. In an embodiment, multiple work orders are generated for every purchase order in collaboration system 110. In an embodiment, work order 116 is generated for each item of the purchase order or each schedule line of the purchase order. In an embodiment, user 102 is a customer and user 104 is a supplier.

Work order 116 is typically a collaboration object, generally a document including a supply chain related information provided by user 102 and user 106. From a business perspective, work order 116 covers the functional needs of outsourced manufacturing requirements. In an embodiment, user 104 carries out a production of goods as prescribed by user 102 before delivering the goods to user 102. Typically, work order 116 includes the following information:
Production information and delivery information, typically including production request and delivery request from user 102 to user 104, and production confirmation and delivery confirmation from user 104 to user 102;
Production and delivery agreement which is an agreed plan between user 102 and user 104;
Production information including production steps which are also known as phases, attachments and parameters;
Production progress actual data;
Production outputs: yield, scrap, on-hold, reworked;
Batch/Lot number assignment (planned and actual);
User-specific notes for textual communication; and
Process status information on requests, confirmations, phases and item.

Work order 116 may further include a supply chain related information typically having a work order item, a work order delivery, a transport phase, an input in the transport phase and an output in the transport phase, a production phase, an input in the production phase and an output in the production phase. The work order item may typically contain a partner identification information of user 102 and user 104, a goods recipient, and a location information. The partner may include user 102, user 104 and the goods recipient. The work order item also serves as an aggregation point for information of a work order delivery. The delivery information may include information about ordered products, product quantities, requested delivery and shipping time. The delivery information may be received as a request, a confirmation, an actual order and a projected order, or the like from one of user 102 and user 104.

In an embodiment, the delivery information in work order 116 typically includes actual shipping details after the completion of a production run. The actual shipping details generally include a shipping time, a shipping date, a shipping location, a shipping quantity, and actual delivery details including a delivery time, a delivery date, a delivery location, and a delivery quantity. The delivery information in work order 116 is typically represented by a transport phase, where the input in the transport phase includes an information about shipping of a product and the output in the transport phase includes information about delivery of the product. The transport phase typically represents the time period between shipping of products at the ship-from location and delivery of products to ship-to location.

In work order 116, each transport phase is linked to a production phase. The production phase includes information about the required production steps, including a description and a duration of the production steps to be carried out by user 104. Typically, the input in the production phase includes information of a component material, a quantity to be used in each phase, and a point in time the production phase has to begin. The output in the production phase includes information of a resulting product, a quantity resulting from a phase execution and a point in time when the product is received by user 102 or 104. The input and output in the production phase typically indicate a flow of materials through each phase in a production process. Work order 116 may also include a machine setting information, product design details and a production process details.

Typically, the input and the output in the production phase or in the transport phase may include a request phase input and a request phase output generally created by user 102, a confirmation phase input and a confirmation phase output generally created by user 104, an actual phase input and an actual phase output generally reported by user 104 during executing the production of work order 116 by user 102, and a projected phase input and a projected phase output generally calculated by collaboration system 110 based on the actual phase input and a planned phase input and a planned phase output. The data in an agreed plan includes a combination of a request phase input and a confirmation phase output. In an embodiment, the data in the agreed plan includes a combination of the phase inputs and phase outputs of a request phase and a confirmation phase.

Work order 116 typically allows grouping of the inputs and outputs of the request phase and the confirmation phase. A group of the inputs and the outputs resulting from the grouping is typically a production run. The production run generally allows representing a phased production where partial product quantities are produced at different times. For example, a work order item in work order 112 may produce a total quantity of ten products where the production of six products is started and the production of the remaining four products is started at a later point in time.

In an embodiment, user 102 is a customer, and user 104 is a supplier. It would be appreciated by one skilled in the art that either one of users 102 and 104 may take the role of the customer and the supplier. User 102 proposes work order 116. Work order 116 is typically created in user backend 106. Work order 116 is sent at 112 to collaboration system 110. Collaboration system 110 receives work order 116 containing the delivery information. In an embodiment, work order 116 includes the request delivery and a production information. In an embodiment, work order 116 may be published and saved in collaboration system 110. The work order proposed by the customer is typically negotiated between the supplier and customer until an agreed plan is reached. A production run typically implements the agreed work order. In an embodiment, the agreed work order typically consists of an agreed phase input and agreed phase output and a canceled phase input and cancelled phase output. The production run typically links the agreed phase input and output and cancelled phase input and output. Work order 116 after being published is viewable to user 102 and user 104 through a user interface. On viewing work order 116, user 104 may send at 120 a negotiation action for the delivery information through user backend 108 or via a web user interface. In an embodiment, user 102 sends at 118 a negotiation action for the delivery information through user backend 104. The negotiation action is typically selected from a group consisting of an acceptance action, a rejection action, a cancellation action, a counter proposal action and a modify action. Collaboration system 110 receives at 122 the negotiation action for the delivery information in work order 116. Collaboration system 110 detects 124 an input and output pair including a transport phase input and a transport phase output in the transport phase for the delivery information. In an embodiment, if the negotiation action received from user 104 is a modify action, the input and output pair in the transport phase is overwritten with a new input and output pair in the transport phase. In an embodiment, the new input and output pair is made active in the transport phase. The input and output pair existing in the transport phase is retained in collaboration system 110.

Collaboration system 110 determines at 126 an input and output pair including a production phase input and a production phase output in the production phase that is linked to the input and output pair in the transport phase. In an embodiment, if the negotiation action received from user 104 is a counter proposal action, collaboration system 110 generates a new input and output pair in the production phase based on the counter proposal. The new input and output pair in the production phase is then linked to the existing input and output pair in the production phase. The input and output pair existing in the production phase is rejected. The input and output pair existing in the production phase is cancelled if the counter proposal action is accepted by user 102. Typically generating the new input and output pair includes calculating a product quantity for the new production phase output based upon the existing transport phase input and calculating a timestamp of the new production phase output by scheduling a break between the production phase and the transport phase. In an embodiment, if the negotiation action is a cancellation action, the input and output pair in the transport phase is cancelled.

Collaboration system 110 applies at 128 the negotiation action to the input and output pair in the production phase. In an embodiment, if the negotiation action is a rejection action, the input and output pair in the production phase is marked as rejected. In an embodiment if negotiation action is a counter proposal action, the existing input and output pair in the transport phase is cancelled after the counter proposal is accepted by user 102. In an embodiment, the existing input and output pair in the transport phase is rejected based upon the counter proposal action. In an embodiment, if the negotiation action is a modify action, the input and output pair in the production phase is adjusted according to the new input and output pair in the transport phase.

Collaboration system 110 updates the work order based on the negotiation action. Collaboration system 110 saves at 130 the updated work order. The updated work order is published at 132. In an embodiment, user 104 completes the production run. In an embodiment, a work order function in collaboration system 110 detects an input and output pair in the transport phase and determines an input and output pair in production phase.

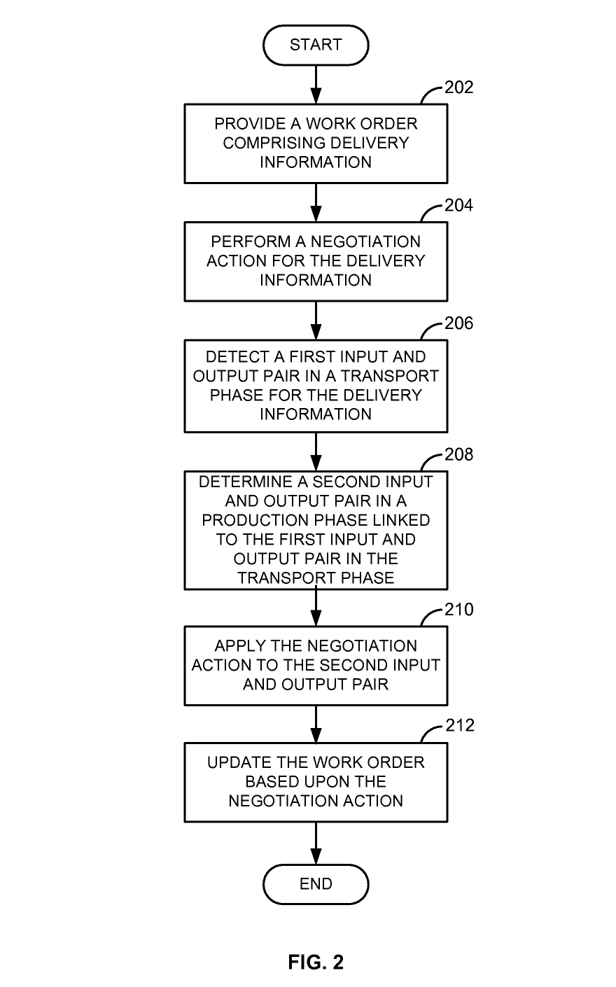

FIG. 2 is a flow diagram of a process for negotiating a work order according to an embodiment of the invention. In process block 202, a work order including delivery information is provided. The work order is typically a document including a supply chain related information and the delivery information provided by one or more users. In process block 204, a negotiation action is performed for the delivery information. In an embodiment, the negotiation action is received from a user. The negotiation action is typically selected from a group consisting of an acceptance action, a rejection action, a cancellation action, a counter proposal action and a modify action. In process block 206, a first input and output pair including a transport phase input and a transport phase output in a transport phase for the delivery information is detected. Typically, the transport phase input in the transport phase represents an information about shipping of a product and the transport phase output in the transport phase includes an information about delivery of the product. The transport phase typically represents the time period between shipping of products at the ship-from location and delivery of products to ship-to location. In an embodiment, a work order function detects the first input and output pair in the transport phase.

In process block 208, a second input and output pair including a production phase input and a production phase output in a production phase linked to the first input and output pair in the transport phase is determined. In an embodiment, the work order function determines the second input and output pair in the production phase. Typically, the second input and output pair in the production phase indicates a flow of materials through the production phase. Typically, the production phase input in the production phase includes information of a component material, a quantity to be used in each phase, and a point in time the production phase has to begin. The production phase output in the production phase includes information of a resulting product, a quantity resulting from a phase execution and a point in time. The production phase typically includes information about the required production steps, including a description and a duration of the production steps to be carried out. In process block 210, the negotiation action is applied to the second input and output pair. In process block 212, the work order is updated based upon the negotiation action

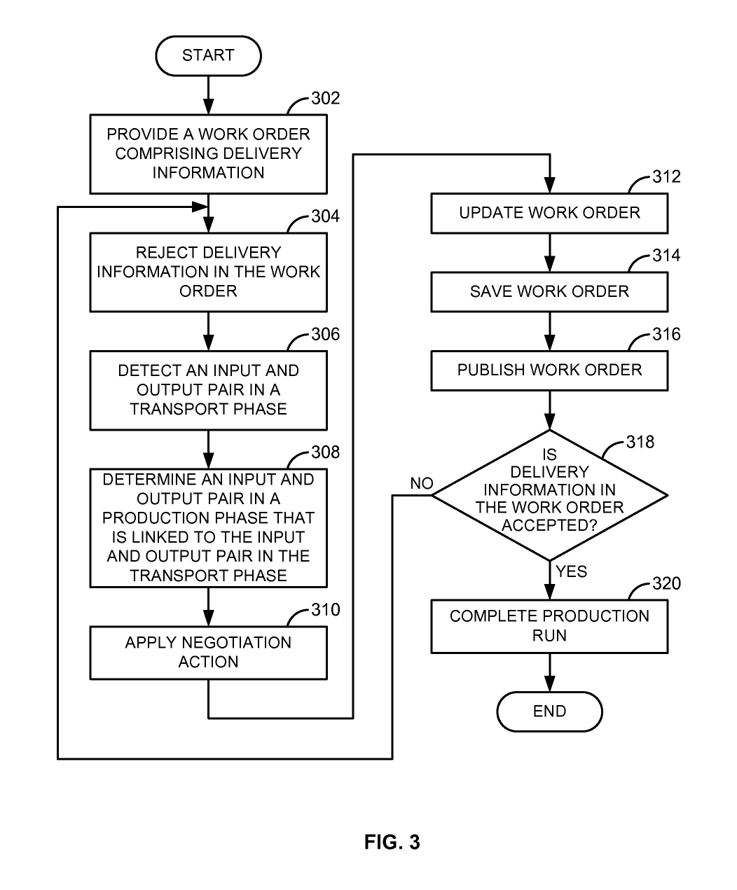

FIG. 3 is a flow diagram of a process for rejecting a work order according to an embodiment of the invention. In process block 302, a work order comprising delivery information is provided. In an embodiment, the work order is provided by a user or generated by a collaboration system. The collaboration system generally helps collaboration between one or more users. The work order is typically a document including a supply chain related information provided by one or more users. The work order covers functional needs of outsourced manufacturing requirements.

In process block 304, the delivery information is rejected by a user or the collaboration system. In process block 306, an input and output pair including a transport phase input and a transport phase output in a transport phase for the delivery information is detected. Typically, the transport phase input in the transport phase represents an information about shipping of a product and the transport phase output in the transport phase includes an information about delivery of the product. The transport phase typically represents the time period between shipping of products at the ship-from location and delivery of products to ship-to location. In an embodiment, a work order function detects the input and output pair in the transport phase that is rejected.

In process block 308, an input and output pair including a production phase input and a production phase output in production phase linked to the input and output pair in the transport phase is determined. In an embodiment, the work order function determines the input and output pair in the production phase. Typically, the input and output in the production phase indicates a flow of materials through a phase in the production process. Typically, the production phase input in the production phase includes information of a component material, a quantity to be used in each phase, and a point in time the production phase has to begin. The production phase output in the production phase includes information of a resulting product, a quantity resulting from a phase execution and a point in time when the product is received. The production phase typically includes information about the required production steps, including a description and a duration of the production steps to be carried out.

In process block 310, the negotiation action is applied to the input and output pair in the production phase. In an embodiment, the work order function applies the rejection action to the linked production phase input and production phase output in the production phase. In process block 312, the work order is updated based upon the rejected delivery information. In process block 314, the work order is saved. In process block 316, the work order is published. In an embodiment, the work order is saved and published in the collaboration system, which is viewed by the user. In decision block 318, if the delivery information in the work order is accepted, the process proceeds to process block 320, where the production run is completed. In an embodiment, the delivery information in the work order is accepted by a user or the collaboration system. The production run generally allows representing a phased production where the partial product quantities are produced at different times. The production run is typically completed by a user. In decision block 318, if the delivery information in the work order is not accepted, the process proceeds to process block 304.

In an embodiment, the delivery information is cancelled by one of the users. The work order function detects the cancelled delivery information. The work order function determines the production phase input and production phase output in the production phase that is linked to the cancelled delivery information. The work order applies cancellation action to the linked input and output pair in the production phase.

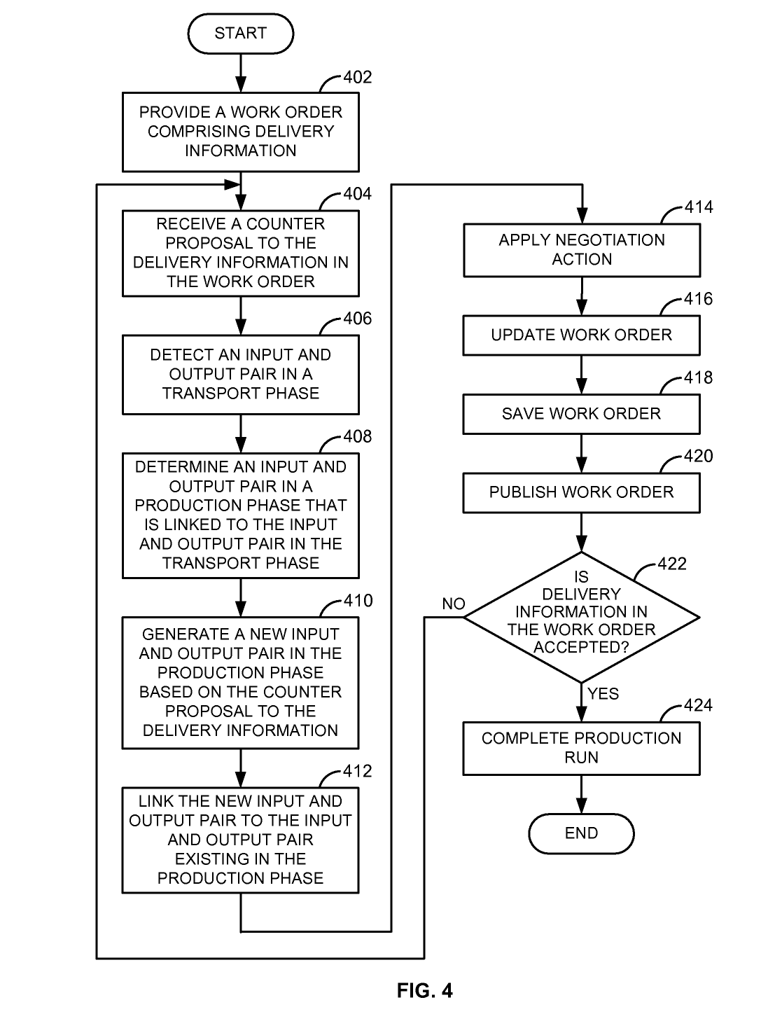

FIG. 4 is a flow diagram of a process for counter proposing a work order according to an embodiment of the invention. In process block 402, a work order including delivery information is provided. In an embodiment, the work order is provided by a user or generated by a collaboration system. The collaboration system generally helps collaboration between one or more users. The work order is typically a document including supply chain related information provided by one or more users. The work order covers functional needs of outsourced manufacturing requirements.

In process block 404, the delivery information is counter proposed by a user or the collaboration system. In process block 406, an input and output including a transport phase input and a transport phase output in a transport phase for the delivery information is detected. Typically, the transport phase input in the transport phase represents an information about shipping of a product and the transport phase output in the transport phase includes an information about delivery of the product. The transport phase typically represents the time period between shipping of products at the ship-from location and delivery of products to ship-to location. In an embodiment, a work order function detects the delivery information in the transport phase that is counter proposed.

In process block 408, an input and output pair including a production phase input and a production phase output in a production phase linked to the input and output pair in the transport phase is determined. In an embodiment, the work order function determines the production phase input and the production phase output in the production phase that is linked to the counter proposed delivery information through production runs. Typically, the input and output pair in the production phase indicates a flow of materials through each phase in the production process. Typically, production phase input in the production phase includes information of a component material, a quantity to be used in each phase, and a point in time the production phase has to begin. The production phase output in the production phase includes information of a resulting product, a quantity resulting from a phase execution and a point in time when the product is received. The production phase includes information about the required production steps, including a description and a duration of the production steps to be carried out. In process block 410, a new input and output pair including new production phase input and new production phase output in production phase is generated in the collaboration system. Typically, the new input and output pair in production phase contains the counter proposed delivery information.

In an embodiment, a product quantity for the new production phase output in the production phase is calculated based upon the existing transport phase input in the transport phase. In an embodiment, a timestamp of the new production phase output in the production phase is calculated by scheduling a break between the transport phase and the production phase.

In process block 412, the new input and output in the production phase is linked to the input and output pair existing in the production phase. In an embodiment, the link between the new input and output pair and the existing input and output pair in the production phase is used to automatically reject the existing input and output pair in production phase. In process block 414, the negotiation action is applied to the new input and output pair in the production phase. In an embodiment, the work order function applies the counter proposal action to the new input and output pair in the production run. In process block 416, the work order is updated based upon the counter proposed delivery information. In process block 418, the work order is saved. In process block 420, the work order is published. In an embodiment, the work order is saved and published in the collaboration system, which is viewed by users. In decision block 422, if the delivery information in work order is accepted, the process proceeds to process block 424, where the production run is completed in an embodiment, the delivery information in the work order is accepted by a user or the collaboration system. The production run generally allows representing a phased production where partial product quantities are produced at different times. The input and output pair existing in the production phase may be cancelled once the new input and output pair in the production phase is accepted. In an embodiment, the input and output pair existing in the production phase may be cancelled based upon the link between the input and output pair existing in the production phase and new input and output pair in the production phase. In decision block 422, if the delivery information in the work order is not accepted, the process proceeds to process block 404.

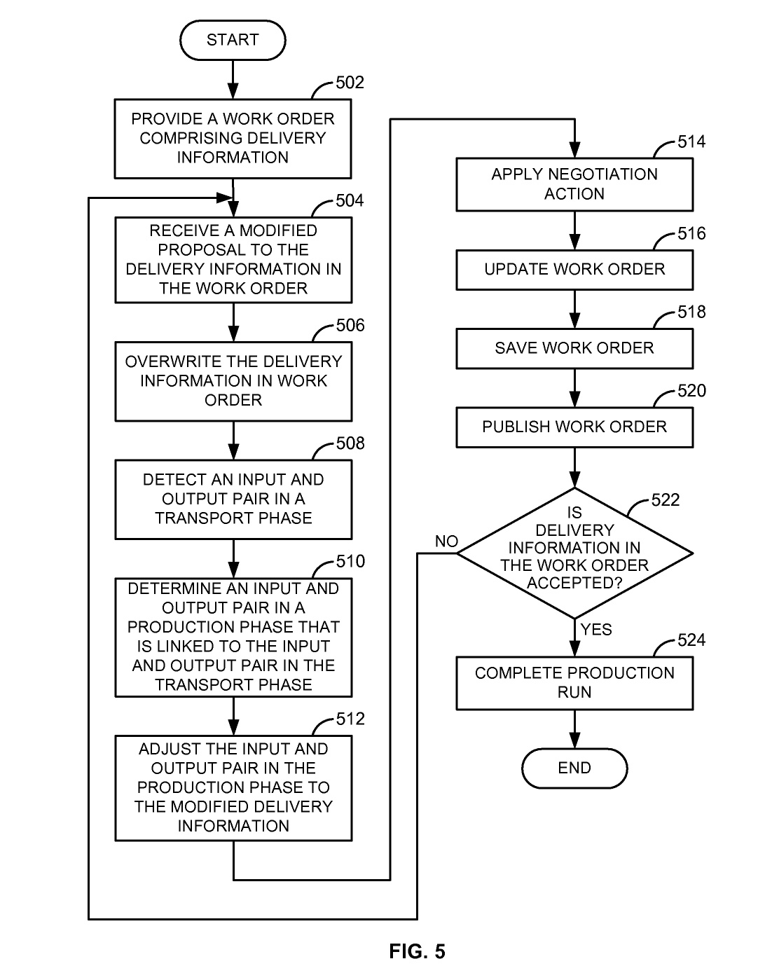

FIG. 5 is a flow diagram of a process for modifying a work order according to an embodiment of the invention. In process block 502, a work order comprising delivery information is provided. In an embodiment, the work order is provided by a user or generated by a collaboration system. The collaboration system generally helps collaboration between one or more users. The work order is typically a document including supply chain related information provided by one or more users. The work order covers functional needs of outsourced manufacturing requirements.

In process block 504, a modified delivery information is proposed by a user or the collaboration system. In process block 506, the delivery information is over-written with the modified delivery information. In process block 508, an input and output pair including a transport phase input and a transport phase output in a transport phase detected. Typically, the transport phase input of the transport phase represents an information about shipping of a product and the transport phase output of the transport phase includes an information about delivery of the product. The transport phase typically represents the time period between shipping of products at the ship-from location and delivery of products to ship-to location. In an embodiment, the input and output pair in the transport phase is over-written. In an embodiment, the work order function determines the input and output pair in the transport phase that is over-written.

In process block 510, an input and output pair including a production phase input and a production phase output in the production phase linked to the input and output pair in transport phase is determined. In an embodiment, the work order function determines the input and output pair in the production phase. Typically, the input and output pair in the production phase indicates a flow of materials through each phase in the production process. Typically, the production phase input in the production phase includes information of a component material, a quantity to be used in each phase, and a point in time the production phase has to begin. The production phase output in the production phase includes information of a resulting product, a quantity resulting from a phase execution and a point in time when the product is received by a user. The production phase typically includes information about the required production steps, including a description and a duration of the production steps to be carried out. In process block 512, the input and output pair in production phase is adjusted to the modified delivery information.

In process block 514, the negotiation action is applied to the input and output pair in the production phase. In an embodiment, a work order function applies the modification action to the linked input and output pair in the production phase. In process block 516, the work order is updated based upon the modified delivery information. In process block 518, the work order is saved. In process block 520, the work order is published. In an embodiment, the work order is saved and published in the collaboration system, which is viewed by the user. In decision block 522, if the delivery information in work order is accepted, the process proceeds to process block 524, where the production run is completed. In an embodiment, the delivery information in the work order is accepted by a user or the collaboration system. The production run generally allows representing a phased production where partial product quantities are produced at different times. The production run is typically completed by a user. In decision block 522, if the delivery information in the work order is not accepted, the process proceeds to process block 504.

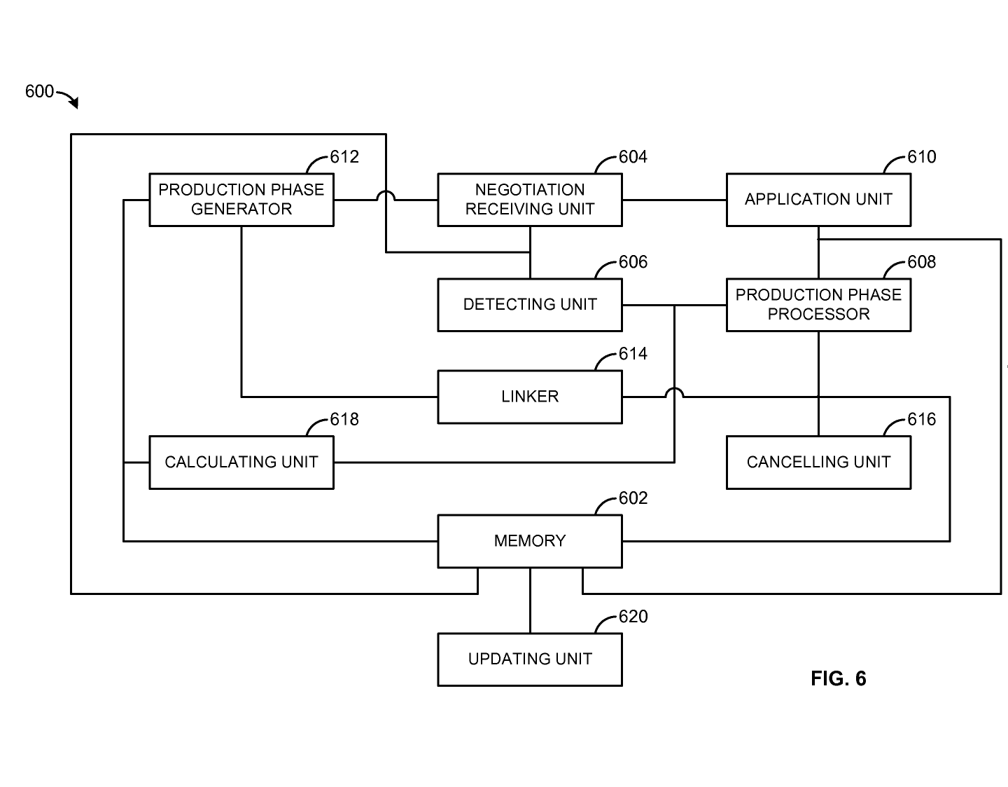

FIG. 6 is a block diagram of system 600 for negotiating a work order according to an embodiment of the invention. System 600 includes memory 602, negotiation receiving unit 604, detecting unit 606, production phase processor 608, application unit 610, production phase generator 612, linker 614, cancelling unit 616, calculating unit 618 and updating unit 620. According to an embodiment, memory 602 is typically connected to negotiation receiving unit 604, detecting unit 606, production phase processor 608, application unit 610, production phase generator 612, linker 614, cancelling unit 616, calculating unit 618 and updating unit 620. Negotiation receiving unit is typically connected to detecting unit 606, application unit 610 and production phase generator. Detecting unit 606 is further connected to production phase processor 608 and calculating unit 618. Production phase processor is typically connected to cancelling unit 616 and application unit 610. Production phase generator is typically connected to linker 614 and calculating unit 618. Linker 614 is further connected to cancelling unit 616 and production phase processor 608.

Negotiation receiving unit 604 typically receives a negotiation action on delivery information in a work order. The work order is typically a document including supply chain related information provided by one or more users. The work order covers functional needs of outsourced manufacturing requirements. In an embodiment, the work order is received by a user. In an embodiment, the work order including the delivery information is stored in memory 602. The negotiation action is typically selected from a group consisting of an acceptance action, a rejection action, a cancellation action, a counter proposal action and a modify action.

Detecting unit 606 typically detects an input and output pair including a transport phase input and a transport phase output in a transport phase for the delivery information. Typically, the transport phase input of the transport phase represents an information about shipping of a product and the transport phase output of the transport phase includes an information about delivery of the product. The transport phase typically represents the time period between shipping of products at the ship-from location and delivery of products to ship-to location.

Production phase processor 608 typically determines an input and output pair including a production phase input and a production phase output in a production phase linked to the input and output pair in the transport phase. Typically, the input and output pair in the production phase indicates a flow of materials through each phase in the production process. Typically, the production phase input in the production phase includes information of a component material, a quantity to be used in each phase, and a point in time the production phase has to begin. The production phase output in the production phase includes information of a resulting product, a quantity resulting from a phase execution and a point in time when the product is received by user. The production phase includes information about the required production steps, including a description and a duration of the production steps to be carried out by a user. Application unit 610 typically applies a negotiation action. The negotiation action is usually applied to the input and output pair in the production phase.

Production phase generator 612 typically generates a new input and output pair in the production phase based on a counter proposal to the delivery information. Linker 614 typically links the new input and output pair in the production phase to the input and output pair existing in the production phase. Cancelling unit 616 typically cancels delivery information if the negotiation action is a cancelling action. In an embodiment, cancelling unit 616 cancels the existing input and output pair if the counter proposed delivery information is accepted. In an embodiment, cancelling unit 616 overwrites the delivery information, if the negotiation action is a modify action. Production phase processor adjusts the input and output pair in the production phase based upon the delivery information that is over written by cancelling unit 616.

Calculating unit 618 typically calculates a product quantity for the production phase output of the production phase based upon the transport phase input from the transport phase. Calculating unit 618 also calculates a timestamp of the production phase output of the production phase by scheduling a break between the production phase and transport phase. Calculating unit 618 also calculates the production phase inputs by scheduling production phase and the transport phase.

Updating unit 620 typically updates the work order stored in the memory based upon after the negotiation action is applied. Updating unit 620 also publishes the work order. In an embodiment, the work order is published in the collaboration system by updating unit, which is viewed by the user. Depending upon the delivery information in the work order, one or more users may react by proposing a negotiation action, or giving a confirmation to the delivery information.

Memory 602 typically stores the work order, the delivery information in the work order, the negotiation actions applied by application unit 610, the negotiation action selected by a user, an input and output pair in transport phase detected by detecting unit 606, an input and output pair in production phase determined by production phase processor 608, a new input and output pair in production phase generated by production phase generator 612, link established by linker 614, cancelled information generated by cancelling unit 616, product quantity and time stamp information calculated by calculating unit 618, and updated work order typically updated by updating unit 620.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
providing a work order, the work order comprising delivery information;
performing a negotiation action for the delivery information;
detecting a first input and output pair including a first transport phase input and a first transport phase output in a transport phase for the delivery information;
determining a second input and output pair including a second production phase input and a second production phase output in a production phase linked to the first input and output pair;
applying the negotiation action to the second pair of input and output; and
updating the work order based upon the negotiation action.

2. The method of claim 1 further comprising:
generating a third input and output pair including a third production phase input and a third production phase output in the production phase based upon a counter proposal to the delivery information;
linking the third input and output pair to the second input and output pair; and
cancelling the second input and output pair if the counter proposal is accepted.

3. The method of claim 2, wherein the step of generating a third input and output pair further comprises:
calculating a product quantity for the third production phase output based upon the first transport phase input; and
calculating a timestamp of the third production phase output by scheduling a backward break between the production phase and the transport phase.

4. The method of claim 1 further comprising the step of cancelling the delivery information if the negotiation action includes a cancellation action.

5. The method of claim 1 further comprising:
overwriting the first input and output pair if the negotiation action includes a modify action; and
overwriting the second input and output pair if the negotiation action includes the modify action.

6. The method of claim 1, wherein performing a negotiation action comprises performing an action selected from a group consisting of an acceptance action, a rejection action, a cancellation action, a counter proposal action and a modify action.

7. The method of claim 1 further comprising:
updating the work order; and
publishing the work order.

8. A system comprising:
a negotiation receiving unit to receive a negotiation action on delivery information in a work order;
a detecting unit electronically coupled to the negotiation receiving unit for detecting a first input and output pair including a first transport phase input and a first transport phase output in a transport phase for the delivery information;
a production phase processor electronically coupled to the detecting unit for determining a second input and output pair including a second production phase input and a second production phase output linked to the first input and output pair in a production phase; and
an application unit electronically coupled to the negotiation receiving unit for applying the negotiation action to the second input and output pair.

9. The system of claim 8 further comprising:
a production phase generator electronically coupled to the detecting unit and the application unit for generating a third input and output pair including a third production phase input and a third production phase output in the production phase based on a counter proposal to the delivery information;
a linker electronically coupled to the production phase processor for linking the third input and output pair to the second input and output pair;
a cancelling unit electronically coupled to the production phase processor and the linker for cancelling the second input and output pair if the counter proposal is accepted; and
updating unit electronically coupled to a memory, for updating the work order.

10. The system of claim 8 further comprising a calculating unit for calculating a product quantity for the third production phase output based upon the first transport phase input from the transport phase and a timestamp of the third production phase output of the production phase by scheduling a backward break between the production phase and the transport phase.

11. The system of claim 7 further comprising the updating unit for publishing the work order.

12. A machine-accessible medium that provides instructions that, when executed by a machine, cause the machine to perform operations comprising:
providing a work order, the work order comprising delivery information;
performing a negotiation action for the delivery information;
detecting a first input and output pair including a first transport phase input and a first transport phase output in a transport phase for the delivery information;
determining a second input and output pair including a second production phase input and a second production phase output in a production phase linked to the first input and output pair;
applying the negotiation action to the second pair of input and output; and
updating a work order based on the negotiation action.

13. The machine-accessible medium of claim 12, further comprising:
generating a third input and output pair including a third production phase input and a third production phase output in the production phase based upon a counter proposal to the delivery information;
linking the third input and output pair to the second input and output pair; and
cancelling the second input and output pair if the counter proposal is accepted.

14. The machine-accessible medium of claim 12 wherein the step of generating a third input and output pair further comprises:
calculating a product quantity for the third production phase output based upon the first transport phase input; and
calculating a timestamp of the third production phase output by scheduling a backward break between the production phase and the transport phase.

15. The method of claim 12 further comprising the step of cancelling the delivery information if the negotiation action includes a cancellation action.

16. The method of claim 12 further comprising:
overwriting the first input and output pair if the negotiation action includes a modify action; and
overwriting the second input and output pair if the negotiation action includes the modify action.

17. The machine accessible medium of claim 12, wherein performing a negotiation action comprises performing an action selected from a group consisting of an acceptance action, a rejection action, a cancellation action, a counter proposal action and a modify proposal action.

18. The machine accessible medium of claim 1 further comprising:
updating the work order; and
publishing the work order.
